(19) United States
(12) Patent Application Publication
(10) Pub. No.: US 2010/0252971 A1
(43) Pub. Date: Oct. 7, 2010

(54) PROTECTIVE TUBE FOR COIL SPRING OF VEHICLE SUSPENSION DEVICE

(75) Inventor: Won Sik Lee, Seoul (KR)

Correspondence Address: HAMRE, SCHUMANN, MUELLER & LARSON, P.C., P.O. BOX 2902, MINNEAPOLIS, MN, 55402-0902, US

(73) Assignee: Dong Yang Physical & Chemical, Anseong-si (KR)

(21) Appl. No.: 12/536,899

(22) Filed: Aug. 6, 2009

(30) Foreign Application Priority Data
Apr. 2, 2009 (KR) 10-2009-0028504

(51) Int. Cl. F16F 13/00

(52) U.S. Cl. 267/140.11

(57) ABSTRACT

Disclosed is a protective tube for a coil spring of a vehicle suspension device. The protective tube includes a cut-out portion through which the coil spring is fitted therein. The cut-out portion has a pair of upper and lower outwardly protruding wings. The wings are joined to each other by high-frequency welding. The protective tube prevents foreign materials from entering the cut-out portion. In addition, the protective tube is easy to manufacture by molding.

### BACKGROUND OF THE INVENTION

1. Field of the Invention

The present invention relates to a protective tube for a coil spring of a vehicle suspension device, and more specifically to a protective tube that has a cut-out portion formed with wings through which a coil spring of a vehicle suspension device is fitted therein to prevent the ingress of foreign materials and achieve improved durability.

2. Description of the Related Art

In general, suspension devices installed in a vehicle absorb shocks applied to the wheels during driving to protect the driver and the other internal devices of the vehicle from the shocks while bringing the driver a comfortable feeling.

Leaf springs and coil springs have been used in suspension devices. Particularly, coil springs have been mounted on most passenger cars. In view of this situation, extensive research and development has been conducted on coil springs for vehicle suspension devices.

FIG. 1 is a schematic view of an exemplary vehicle suspension device according to the related art. The suspension device 4 is installed between a frame 1 and an axle 2 connected to a wheel 3 below the frame 1 to maintain the movement of the axle 2 against the frame 1 in an elastic manner. The suspension device 4 includes an upper spring seat assembly 5 installed on the frame 1, a lower spring seat assembly 6 installed on the axle 2, and a coil spring 9 installed between the upper and lower spring seat assemblies 5 and 7. A rubber-made upper spring pad 6 is interposed between the coil spring 9 and the upper spring seat assembly 5, and a rubber-made lower spring pad 8 is interposed between the coil spring 9 and the lower spring seat assembly 7.

The upper and lower spring pads 6 and 8 are accommodated in the upper and lower spring seat assemblies 5 and 7, to which the upper and lower end portions of the coil spring 9 are coupled, respectively. However, the pads 6 and 8 are liable to be compressed and ruptured by a weak shock to lose their elasticity. When the pads 6 and 8 are torn, the upper and lower end portions of the coil spring 9 come into contact with the upper and lower spring seat assemblies 5 and 7, respectively. This contact brings about noise and allows direct transfer of the shock from the coil spring 9 to the upper and lower spring seat assemblies 5 and 7, resulting in damage to the upper and lower spring seat assemblies 5 and 7.

In an attempt to solve the problems of the related art, the present applicant has proposed a protective tube fitted onto a coil spring in Korean Utility Model Registration No. 370482. A perspective view of the protective tube is illustrated in FIG. 2.

As illustrated in FIG. 2, the protective tube 20 has a cut-out portion 23 formed along the inner circumference of a ring-shaped body 21. The cut-out portion 23 is configured to wind two turns from each of the upper and lower ends of a coil spring, so that shocks and noise between the coil spring and upper and lower spring seat assemblies can be reduced.

However, there is always the potential danger that foreign materials may enter the body 21 through the exposed cut-out portion 23. That is, foreign materials (e.g., soil, sand or gravel) on the road during driving or foreign materials deposited on a suspension device may enter the body 21 through the cut-out portion 23. Such foreign materials cause loss of elasticity and shape deformation of the protective tube 20 or increase the risk of damage to the protective tube 20. About half of the protective tube 20 mounted on the coil spring is in contact with the bottom of the coil spring and the other portion thereof is not in contact with the coil spring. This poses the problem that the movement of the coil spring may render the protective 20 tube turnable around the coil spring without being fixed. Thus, there is a need to solve the problems that may lead to poor performance of the protective tube 20.

### SUMMARY OF THE INVENTION

In view of the foregoing and other problems of the related art, an object of the present invention is provide a protective tube for a coil spring of a vehicle suspension device that prevents the ingress of foreign materials to achieve improved durability.

It is another object of the present invention to provide a protective tube for a coil spring of a vehicle suspension device that has reinforcing portions formed on the upper and lower portions thereof to achieve improved durability.

According to an aspect of the present invention, there is provided a protective tube for a coil spring of a vehicle suspension device which includes: a ring-shaped tubular body whose both ends are separated from each other; a plurality of air through-holes formed so as to penetrate the upper and lower portions of the tubular body; and a cut-out portion formed in the lengthwise direction of the tubular body wherein the cut-out portion includes a pair of upper and lower wings protruding outward from the tubular body and joined to each other by high-frequency welding.

The wings may be formed by a suitable molding process, such as injection molding. The wings may be continuously joined to each other along the entire circumference of the cut-out portion by high-frequency welding. In an alternative embodiment, the wings may be intermittently joined to each other at regular intervals by high-frequency welding. The high-frequency welding maintains tight coupling between the wings along the lengthwise direction of the protective tube, thus eliminating the need to form an adhesive layer on the inner surface of the protective tube.

A plurality of reinforcing bands or protrusions may protrude at regular intervals on the surface of the tubular body where the air through-holes are formed. In an alternative embodiment, the reinforcing bands may be formed together with the reinforcing protrusions.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view of a general vehicle suspension device;

FIG. 2 is a perspective view of a protective tube of the related art;

FIG. 3 is a perspective view illustrating a state in which a protective tube according to an exemplary embodiment of the present invention is fitted onto a coil spring;

FIG. 4 is a perspective view illustrating the protective tube of FIG. 3;

FIG. 5 is a longitudinal cross-sectional view illustrating the protective tube of FIG. 4;

FIG. 6 is a longitudinal cross-sectional view illustrating a protective tube for a coil spring according to another exemplary embodiment of the present invention;

FIGS. 7a and 7b are longitudinal cross-sectional views illustrating some shapes of a tubular body of a protective tube for a coil spring according to another exemplary embodiment of the present invention;

FIG. 8 is a perspective view illustrating a protective tube for a coil spring according to another exemplary embodiment of the present invention;

FIG. 9 is a perspective view illustrating a protective tube for a coil spring according to another exemplary embodiment of the present invention; and

FIGS. 10a through 10C are perspective views illustrating some structures of one end of a protective tube for a coil spring according to another exemplary embodiment of the present invention.

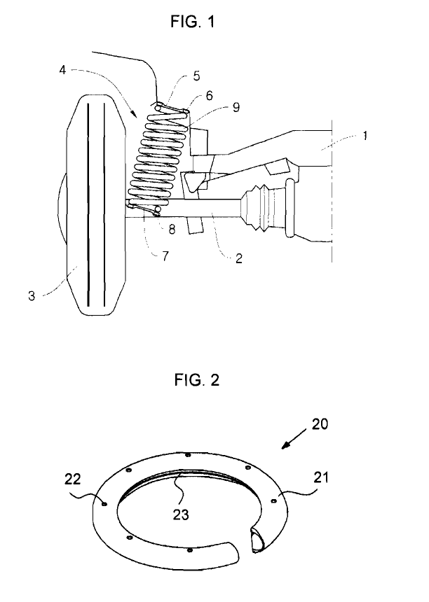

### DETAILED DESCRIPTION OF THE INVENTION

Exemplary embodiments of the present invention will now be described in detail with reference to the accompanying drawings.

The present invention provides a protective tube for a coil spring of a vehicle suspension device, including: a ring-shaped body whose both ends are separated from each other; a plurality of air through-holes formed so as to penetrate the upper and lower portions of the tubular body; and a cut-out portion formed in the lengthwise direction of the tubular body wherein the cut-out portion includes a pair of upper and lower wings protruding outward from the tubular body and joined to each other by high-frequency welding.

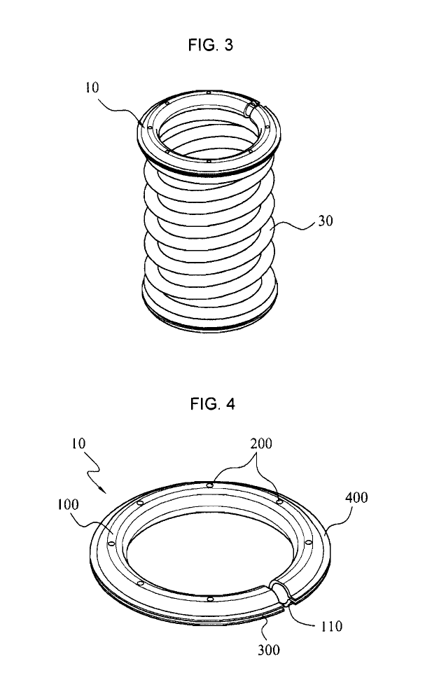

FIG. 3 is a perspective view illustrating a state in which a protective tube according to an exemplary embodiment of the present invention is fitted onto a coil spring of a vehicle suspension device. Referring to FIG. 3, the protective tube 10 is fitted onto each of the upper and lower end portions of the coil spring 30 to absorb shocks and noise generated when the coil spring 30 elastically moves.

FIG. 4 is a perspective view of the protective tube 10. Referring to FIG. 4, the protective tube 10 includes a ring-shaped body 100 whose both ends are separated from each other, a plurality of air through-holes 200 formed so as to penetrate the upper and lower portions of the tubular body 100, and a cut-out portion 300 formed in the lengthwise direction of the tubular body 100. The cut-out portion 300 includes a pair of upper and lower wings 400 protruding outward from the tubular body 100 and joined to each other by high-frequency welding.

The tubular body 100 is formed in the shape of a ring that has an inner diameter greater than the sectional diameter of the coil spring 30. The shape and dimension of the tubular body 100 allows the tubular body 100 to surround and protect each of the upper and lower end portions of the coil spring 30.

The coil spring 30 is continuous from the top to the bottom or vice versa. Due to this continuous structure, one of both ends 110, which are separated from each other, of the tubular body 100 can be fitted onto each of the upper or lower end portions of the coil spring 30.

The tubular body 100 is made of a synthetic rubber or resin. A polyurethane elastomer is preferred as the material for the tubular body 100 because of its high strength, high elasticity and good resistance to wear and impact.

No particular limitation is imposed on the size of the tubular body 100. For example, the tubular body 100 has a thickness of 0.5 to 1.5 mm in the transverse direction, and the thickness of the tubular body 100 may be about 1.5 to 2.5 times greater in the longitudinal direction than in the transverse direction.

The air through-holes 200 are formed at regular intervals so as to penetrate the upper and lower portions of the tubular body 100. The air through-holes 200 allow compressed air from the tubular body 100 to be released to the outside when a load is applied to the coil spring 30.

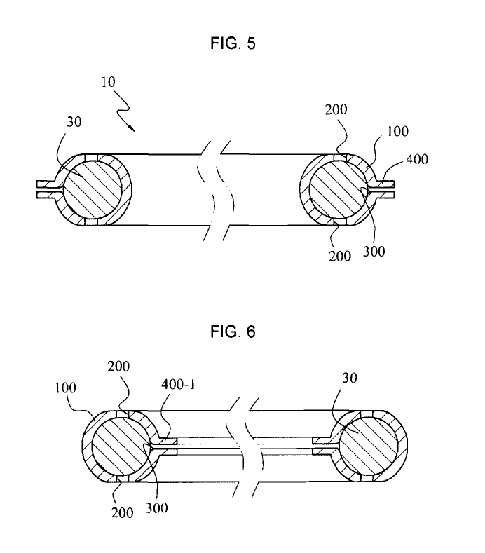

FIG. 5 is a longitudinal cross-sectional view illustrating the coil spring protective tube of FIG. 4. Referring to FIG. 5, the cut-out portion 300 is an opening formed in the lengthwise direction of the protective tube 10 along the outer circumference of the tubular body 100 on a horizontal plane passing through the central axis of the tubular body 100. The cut-out portion 300 enables the coil spring 30 to be easily fitted in and secured to the tubular body 100. That is, the inner and outer sides of the coil spring 30 are sequentially fitted into the tubular body 100 while keeping the cut-out portion 300 wide open.

The pair of upper and lower wings 400 are formed in the cut-out portion 300. The wings 400 protrude outward from the tubular body 100 along both ends of the cut-out portion 300. The wings 400 may be integrally molded with the tubular body 100 or may be formed separately from the tubular body 100. After the protective tube 10 is fitted onto the coil spring 30, the wings can be joined to each other by high-frequency welding. Dedicated welding jigs are used in joining the wings by high-frequency welding. The wings 400 may be welded as a whole or may be intermittently welded at points spaced at regular intervals.

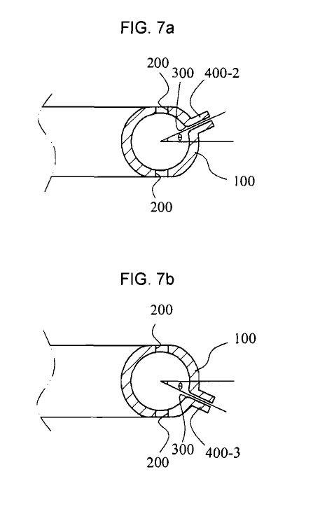

FIGS. 6, 7a and 7b are longitudinal cross-sectional views illustrating some exemplary embodiments of the protective tube 10 of the present invention.

Referring to FIG. 6, the cut-out portion 300 may be formed along the inner circumference of the tubular body 100. In this embodiment, the outer and inner sides of the coil spring 30 are sequentially fitted into the tubular body 100 while keeping the cut-out portion 300 wide open.

In the other embodiments, the cut-out portion 300 may be formed at an angle with respect to a horizontal plane passing through the central axis of the tubular body 100, along the inner or outer circumference of the tubular body 100. Specifically, the cut-out portion 300 may be formed upward (FIG. 7a) or downward (FIG. 7b) at a predetermined angle (θ) with respect to the horizontal plane. The inclined cut-out portion 300 enables the tubular body 100 to be fixedly secured to the coil spring 30 without any distortion in the shape of the tubular body 100 even when a vertical or horizontal force is applied to the coil spring 300. Further, the inclined cut-out portion 300 can be prevented from interfering with a lower plate and can protect the protective tube 10 from the ingress of foreign materials, contributing to noise reduction. The angle (θ) may vary depending on the angle of the counterpart (e.g., the coil spring). The angle (θ) is not particularly limited, and for example, may be from about 40° to about 50°. It is preferred to adjust the angle (θ) to about 45°.

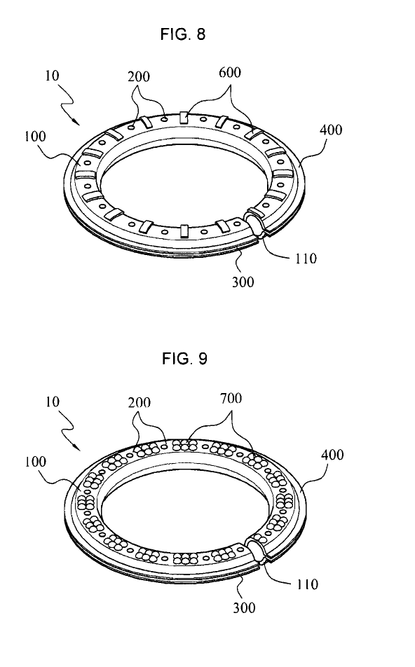

FIG. 8 illustrates a plurality of reinforcing bands 600 protruding at regular intervals along the periphery of the tubular body 100 where the air through-holes 200 are formed. The reinforcing bands 600 are formed by molding. The reinforcing bands 600 have a small contact area with an upper or lower spring seat assembly and are formed with inclined surfaces. Due to this structure, the reinforcing bands 600 serve to distribute a load resulting from the friction between the coil spring 6 and the corresponding spring seat assembly over the entire surface of the tubular body 100 without being concentrated on particular portions.

FIG. 9 is a perspective view illustrating the protective tube 10 having reinforcing protrusions 700. The reinforcing protrusions 700 may be formed so as to protrude at regular intervals on the upper and lower portions of the tubular body 100. The reinforcing protrusions 700 reinforce the upper and lower portions of the tubular body 100 where the protective tube 10 is in direct contact with a spring seat assembly to improve the durability of the protective tube 10. In addition, the reinforcing protrusions 700 protect the air through-holes 200 from being closed by the spring seat assembly. The size and shape of the reinforcing protrusions 700 are not particularly limited. For example, the reinforcing protrusions 700 may be hemispherical in shape. Further, the reinforcing protrusions may have different sizes. The reinforcing protrusions 700 may also be formed together with the reinforcing bands 600.

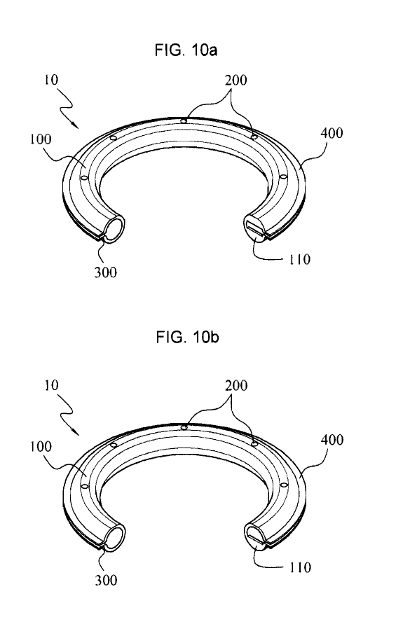

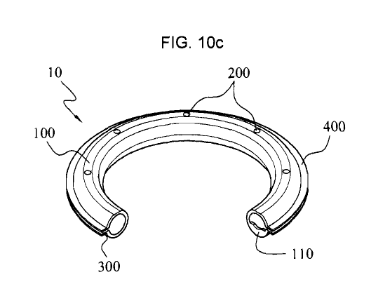

One end 110 of both open ends of the protective tube 10 fitted onto the coil spring 30 may be closed to prevent direct contact with steel of a support panel. Exemplary structures of the protective tube 10 are illustrated in FIGS. 10a through 10c.

Hereinafter, an explanation will be given of how to apply the protective tube 10 to the coil spring 30 of the vehicle suspension device.

The protective tube 10 is fitted onto each of the upper and lower end portions of the coil spring 30 to reduce shock and friction between the coil spring 30 and the corresponding spring seat assembly of the suspension device, contributing to noise reduction. In addition, the protective tube 10 protects the coil spring 30 from wear to improve the durability of the coil spring 30.

First, the protective tube 10 is fitted onto each of the upper and lower end portions of the coil spring 30 while keeping the cut-out portion 300, which is formed along the inner or outer circumference of the tubular body 100, wide open. The end 110 of the tubular body 100 limits the length of the coil spring 30 fitted into the protective tube 10 to the length of the protective tube 10 in contact with the corresponding spring seat assembly. In the state in which the coil spring 30 is fitted into the protective tube 10, the pair of upper and lower wings are joined to each other by high-frequency welding. The welding may be performed in such a manner that the wings formed along the circumference of the tubular body 100 are continuously joined to each other as a whole. Alternatively, the wings may be intermittently joined to each other at regular intervals. The tubular body 100 can be fixedly attached to the coil spring 30 by pressing.

The wings 400 formed in the cut-out portion 300 prevent foreign materials (e.g., soil or sand) from entering the tubular body 100, so that the protective tube 10 can be protected from deformation due to the foreign materials. As a result, the protective tube 10 does not undergo loss of elasticity and is prevented from slipping off the coil spring 30. The cut-out portion 300 is formed upward or downward with respect to a horizontal plane passing through the central axis of the tubular body 100 so that the protective tube 10 can be installed in a direction so as not to interfere with other devices such as a shock absorber.

The reinforcing bands 600 or reinforcing protrusions 700 are formed on the upper and lower portions of the tubular body 100 to reduce wear resulting from the friction between the protective tube 10 and an upper or lower spring seat assembly. In addition, the air through-holes 200 are spaced away from the upper and lower spring seat assemblies by the reinforcing bands 600 or reinforcing protrusions 700, ensuring a smooth flow of compressed air from the protective tube 10 into the outside therethrough.

As is apparent from the foregoing, the pair of upper and lower wings are formed along the cut-out portion of the protective tube and are joined to each other by high-frequency welding to block the ingress of foreign materials through the cut-out portion. In addition, reinforcing protrusions are formed on the tubular body to improve the durability of the protective tube.

While the present invention has been described in detail in connection with certain exemplary embodiments thereof, the embodiments are merely for illustrative purposes and are not intended to limit the scope of the invention. It will be understood by those skilled in the art that various substitutions, modifications and changes are possible, without departing from the scope and spirit of the invention as disclosed in the accompanying claims.

What is claimed is:

1. A protective tube for a coil spring of a vehicle suspension device, comprising: a ring-shaped tubular body whose both ends are separated from each other; a plurality of air through-holes formed so as to penetrate the upper and lower portions of the tubular body; and a cut-out portion formed in the lengthwise direction of the tubular body wherein the cut-out portion comprises a pair of upper and lower wings protruding outward from the tubular body and joined to each other by high-frequency welding.

2. The protective tube of claim 1, wherein the wings are continuously joined to each other as a whole or are intermittently joined to each other at regular intervals by high-frequency welding.

3. The protective tube of claim 1, wherein the cut-out portion is formed along the inner or outer circumference of the tubular body.

4. The protective tube of claim 1, wherein the cut-out portion is formed at an angle with respect to a horizontal plane passing through the central axis of the tubular body.

5. The protective tube of claim 1, further comprising a plurality of reinforcing bands protruding at regular intervals on the surface of the tubular body where the air through-holes are formed.

6. The protective tube of claim 1, further comprising a plurality of reinforcing protrusions formed at regular intervals on the surface of the tubular body where the air through-holes are formed.

7. The protective tube of claim 1, wherein one end of both ends of the protective tube fitted onto the coil spring is closed.
